(19) United States
(12) Patent Application Publication
(10) Pub. No.: US 2024/0161312 A1
(43) Pub. Date: May 16, 2024

(54) REALISTIC DISTRACTION AND PSEUDO-LABELING REGULARIZATION FOR OPTICAL FLOW ESTIMATION

(71) Applicant: QUALCOMM Incorporated, San Diego, CA (US)

(72) Inventors: Jisoo JEONG, San Diego, CA (US); Risheek GARREPALLI, San Diego, CA (US); Hong CAI, San Diego, CA (US); Fatih Murat PORIKLI, San Diego, CA (US)

(21) Appl. No.: 18/477,493

(22) Filed: Sep. 28, 2023

Related U.S. Application Data
(60) Provisional application No. 63/424,836, filed on Nov. 11, 2022.

(51) Int. Cl. G06T 7/246

(52) U.S. Cl. CPC G06T 7/248; G06T 2207/10016; G06T 2207/20081; G06T 2207/20084

(57) ABSTRACT

A computer-implemented method includes generating a first augmented frame by combining a first image and a first frame of a first frame pair. The computer-implemented method also includes generating, via an optical flow estimation model, a first flow estimation based on a second frame of the first frame pair and the first augmented frame. The computer-implemented method further includes updating one or both of parameters or weights of the optical flow estimation model based on a first loss between the first flow estimation and a training target.

### CROSS-REFERENCE TO RELATED APPLICATION

The present application claims the benefit of U.S. Provisional Patent Application No. 63/424,836, filed on Nov. 11, 2022, and titled “REALISTIC DISTRACTION AND PSEUDO-LABELING REGULARIZATION FOR OPTICAL FLOW ESTIMATION,” the disclosure of which is expressly incorporated by reference in its entirety.

### FIELD OF THE DISCLOSURE

Aspects of the present disclosure generally relate to optical flow estimation, and more specifically to training optical flow estimation models via realistic distraction and pseudo-labeling regularization.

### BACKGROUND

Artificial neural networks may comprise interconnected groups of artificial neurons (e.g., neuron models). The artificial neural network may be a computational device or be represented as a method to be performed by a computational device. Convolutional neural networks are a type of feed-forward artificial neural network. Convolutional neural networks may include collections of neurons that each have a receptive field and that collectively tile an input space. Convolutional neural networks (CNNs), such as deep convolutional neural networks (DCNs), have numerous applications. In particular, these neural network architectures are used in various technologies, such as image recognition, computer vision, speech recognition, acoustic scene classification, keyword spotting, autonomous driving, and other classification tasks.

Optical flow estimation is an example of a computer vision task that may be used for various applications, such as, for example, image processing, autonomous driving, and/or robotics. The optical flow may be an estimate of a respective movement of each pixel from a first frame to a second frame. In driving scenarios, a vehicle may use optical flow estimation to determine a direction of movement for one or more objects in an environment. In image processing, optical flow estimation may be used for various features, such as image stabilization.

### SUMMARY

In one aspect of the present disclosure, a computer-implemented method generating a first augmented frame by combining a first image and a first frame of a first frame pair. The computer-implemented method also includes generating, via an optical flow estimation model, a first flow estimation based on a second frame of the first frame pair and the first augmented frame. The computer-implemented method further includes updating one or both of parameters or weights of the optical flow estimation model based on a first loss between the first flow estimation and a training target.

Another aspect of the present disclosure is directed to an apparatus including means for generating a first augmented frame by combining a first image and a first frame of a first frame pair. The apparatus also includes means for generating, via an optical flow estimation model, a first flow estimation based on a second frame of the first frame pair and the first augmented frame. The apparatus further includes means for updating one or both of parameters or weights of the optical flow estimation model based on a first loss between the first flow estimation and a training target.

In another aspect of the present disclosure, a non-transitory computer-readable medium with non-transitory program code recorded thereon is disclosed. The program code is executed by one or more processors and includes program code to generate a first augmented frame by combining a first image and a first frame of a first frame pair. The program code also includes program code to generate, via an optical flow estimation model, a first flow estimation based on a second frame of the first frame pair and the first augmented frame. The program code further includes program code to update one or both of parameters or weights of the optical flow estimation model based on a first loss between the first flow estimation and a training target.

Another aspect of the present disclosure is directed to an apparatus having one or more processors, and one or more memories coupled with the one or more processors and storing instructions operable, when executed by the one or more processors, to cause the apparatus to generate a first augmented frame by combining a first image and a first frame of a first frame pair. Execution of the instructions also cause the apparatus to generate, via an optical flow estimation model, a first flow estimation based on a second frame of the first frame pair and the first augmented frame. Execution of the instructions further cause the apparatus to update one or both of parameters or weights of the optical flow estimation model based on a first loss between the first flow estimation and a training target.

Another aspect of the present disclosure is directed to an apparatus having one or more processors, and one or more memories coupled with the one or more processors and storing instructions operable, when executed by the one or more processors, to cause the apparatus to receive a first frame and a second frame. Execution of the instructions also cause the apparatus to estimate, via an optical flow estimation model, an optical flow between the first frame and the second frame, the optical flow estimation model being trained by: generating a first augmented frame by combining a first image and a first training frame of a training frame pair; generating a first flow estimation based on a second training frame of the training frame pair and the first augmented frame; and updating one or both of parameters or weights of the optical flow estimation model based on a first loss between the first flow estimation and a training target.

Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 illustrates an example implementation of a neural network using a system-on-a-chip (SOC), including a general-purpose processor in accordance with certain aspects of the present disclosure.

FIGS. 2A, 2B, and 2C are diagrams illustrating a neural network in accordance with various aspects of the present disclosure.

FIG. 2D is a diagram illustrating an exemplary deep convolutional network (DCN) in accordance with various aspects of the present disclosure.

FIG. 3 is a block diagram illustrating an exemplary deep convolutional network (DCN) in accordance with various aspects of the present disclosure.

FIG. 4 is a block diagram illustrating an example of a supervised training procedure for optical flow estimation, in accordance with various aspects of the present disclosure.

FIG. 5 is a block diagram illustrating an example of a self-supervised training procedure for optical flow estimation, in accordance with various aspects of the present disclosure.

FIG. 6 is a flow diagram illustrating a process for training an optical flow estimation model, in accordance with various aspects of the present disclosure.

### DETAILED DESCRIPTION

The detailed description set forth below, in connection with the appended drawings, is intended as a description of various configurations and is not intended to represent the only configurations in which the concepts described may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method practiced using other structure, functionality, or structure and functionality in addition to or other than the various aspects of the disclosure set forth. It should be understood that any aspect of the disclosure disclosed may be embodied by one or more elements of a claim.

The word “exemplary” is used to mean “serving as an example, instance, or illustration.” Any aspect described as “exemplary” is not necessarily to be construed as preferred or advantageous over other aspects.

Although particular aspects are described, many variations and permutations of these aspects fall within the scope of the disclosure. Although some benefits and advantages of the preferred aspects are mentioned, the scope of the disclosure is not intended to be limited to particular benefits, uses or objectives. Rather, aspects of the disclosure are intended to be broadly applicable to different technologies, system configurations, networks and protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

Optical flow estimation is an example of a computer vision task that may be used for various applications, such as, for example, image processing, autonomous driving, and/or robotics. The optical flow may be an estimate a respective movement of each pixel from a first frame to a second frame. In driving scenarios, a vehicle may use optical flow estimation to determine a direction of movement for one or more objects in an environment. In image processing, optical flow estimation may be used for various features, such as image stabilization.

Despite recent advances in computer vision and deep learning, optical flow estimation is still a challenging problem. Conventional optical flow estimation systems fail to accuracy estimate an optical flow. Various aspects of the present disclosure are directed to improving the accuracy of the optical flow estimation. In some examples, a data augmentation process may be specified to train an optical flow estimation model by adding realistic distractions to input frames. In such examples, a frame from an original pair of frames may be mixed with a distractor image from a similar domain, creating a distracted pair. The distracted pair introduces visual perturbations that align with natural objects and scenes, such that an optical flow estimation model may learn semantically meaningful variations, thereby becoming more robust to challenging deviations.

In the training process, two supervised losses may be calculated: one for the original frame pair and its ground-truth flow, and another between the distracted pair's flow and the original pair's ground-truth flow, both weighted by the same mixing ratio. When using unlabeled data, the training process may expand to self-supervised learning based on pseudo-labeling and cross-consistency regularization. The estimated flow of the distracted pair may be adjusted to match a flow associated with the original pair, thereby increasing a number of training pairs without the need for additional annotations. Thus, the training procedure may be improved by leveraging unlabeled data, because ground truth optical flow annotations are difficult to obtain in the real world. This augmentation approach may be model-agnostic and applicable to any optical flow estimation model.

Particular aspects of the subject matter described in this disclosure can be implemented to realize one or more of the following potential advantages. In some examples, the described techniques, such as generating a first augmented frame and a second augmented frame, generating, via an optical flow estimation model, a first flow estimation based on the first frame and the second augmented frame, and updating one or both of parameters or weights of the optical flow estimation model to minimize a first loss between the first flow estimation and a training target, may improve an accuracy of optical flow estimations.

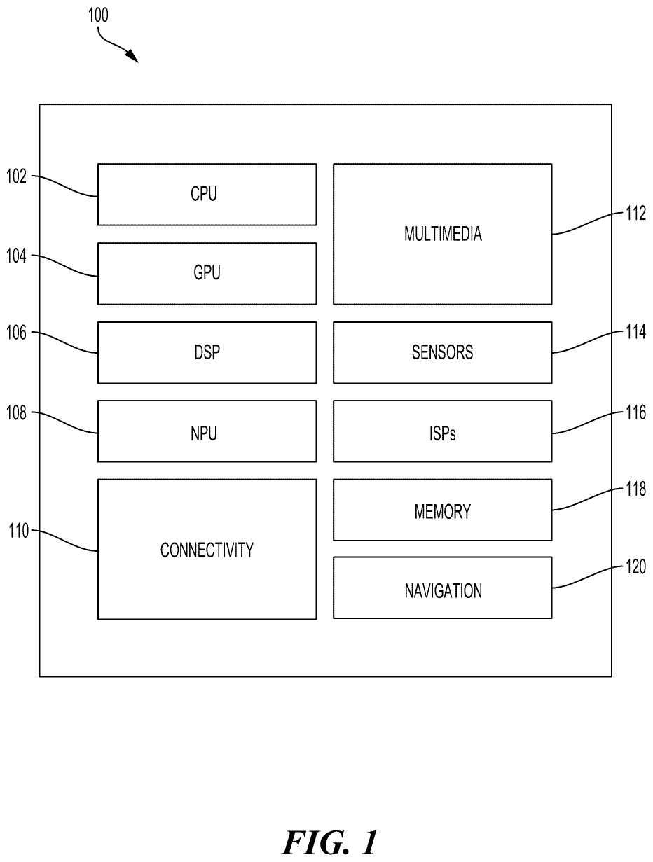

FIG. 1 illustrates an example implementation of a system-on-a-chip (SOC) 100, which may include a central processing unit (CPU) 102 or a multi-core CPU configured for optical flow estimation. Variables (e.g., neural signals and synaptic weights), system parameters associated with a computational device (e.g., neural network with weights), delays, frequency bin information, and task information may be stored in a memory block associated with a neural processing unit (NPU) 108, in a memory block associated with a CPU 102, in a memory block associated with a graphics processing unit (GPU) 104, in a memory block associated with a digital signal processor (DSP) 106, in a memory block 118, or may be distributed across multiple blocks. Instructions executed at the CPU 102 may be loaded from a program memory associated with the CPU 102 or may be loaded from a memory block 118.

The SOC 100 may also include additional processing blocks tailored to specific functions, such as a GPU 104, a DSP 106, a connectivity block 110, which may include fifth generation (5G) connectivity, fourth generation long term evolution (4G LTE) connectivity, Wi-Fi connectivity, USB connectivity, Bluetooth connectivity, and the like, and a multimedia processor 112 that may, for example, detect and recognize gestures. In one implementation, the NPU 108 is implemented in the CPU 102, DSP 106, and/or GPU 104. The SOC 100 may also include a sensor processor 114, image signal processors (ISPs) 116, and/or navigation module 120, which may include a global positioning system.

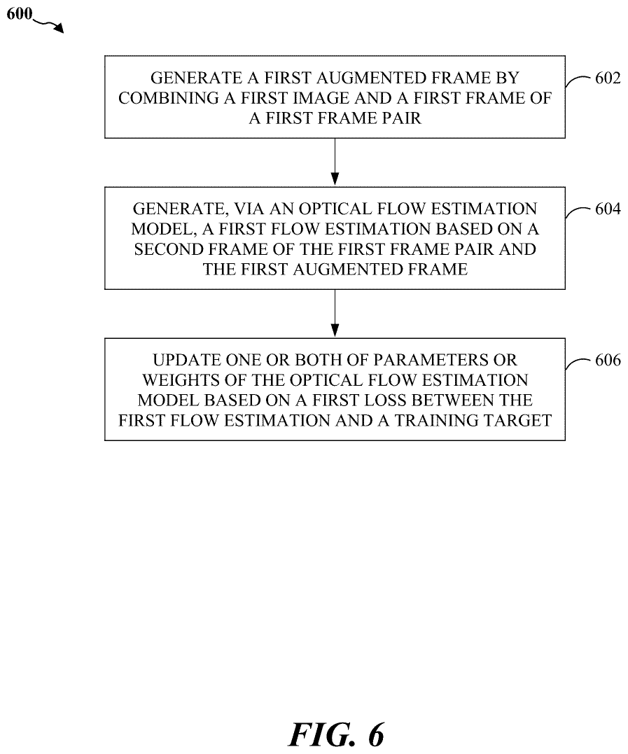

The SOC 100 may be based on an ARM instruction set. In an aspect of the present disclosure, the instructions loaded into the general-purpose processor 102 may include code to perform operations of the process 600 described with reference to FIG. 6.

Deep learning architectures may perform an object recognition task by learning to represent inputs at successively higher levels of abstraction in each layer, thereby building up a useful feature representation of the input data. In this way, deep learning addresses a major bottleneck of traditional machine learning. Prior to the advent of deep learning, a machine learning approach to an object recognition problem may have relied heavily on human engineered features, perhaps in combination with a shallow classifier. A shallow classifier may be a two-class linear classifier, for example, in which a weighted sum of the feature vector components may be compared with a threshold to predict to which class the input belongs. Human engineered features may be templates or kernels tailored to a specific problem domain by engineers with domain expertise. Deep learning architectures, in contrast, may learn to represent features that are similar to what a human engineer might design, but through training. Furthermore, a deep network may learn to represent and recognize new types of features that a human might not have considered.

A deep learning architecture may learn a hierarchy of features. If presented with visual data, for example, the first layer may learn to recognize relatively simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases.

Deep learning architectures may perform especially well when applied to problems that have a natural hierarchical structure. For example, the classification of motorized vehicles may benefit from first learning to recognize wheels, windshields, and other features. These features may be combined at higher layers in different ways to recognize cars, trucks, and airplanes.

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

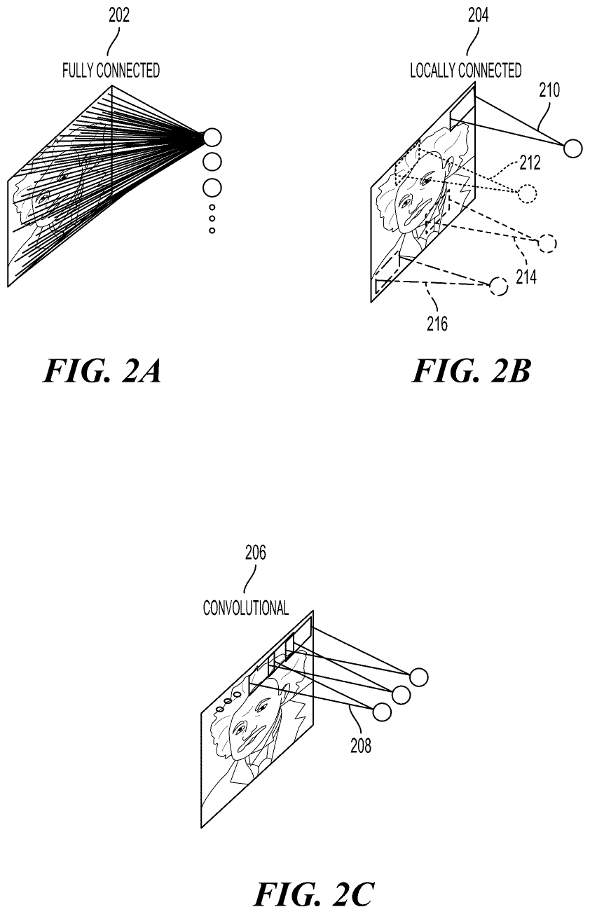

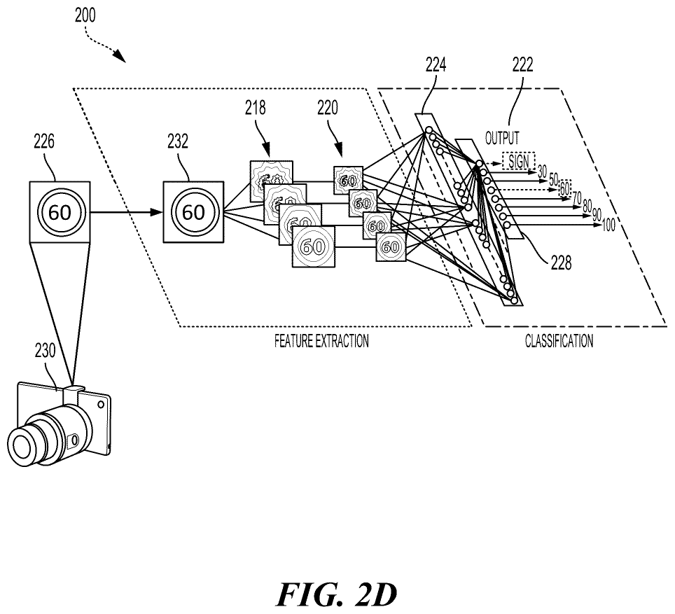

The connections between layers of a neural network may be fully connected or locally connected. FIG. 2A illustrates an example of a fully connected neural network 202. In a fully connected neural network 202, a neuron in a first layer may communicate its output to every neuron in a second layer, so that each neuron in the second layer will receive input from every neuron in the first layer. FIG. 2B illustrates an example of a locally connected neural network 204. In a locally connected neural network 204, a neuron in a first layer may be connected to a limited number of neurons in the second layer. More generally, a locally connected layer of the locally connected neural network 204 may be configured so that each neuron in a layer will have the same or a similar connectivity pattern, but with connections strengths that may have different values (e.g., 210, 212, 214, and 216). The locally connected connectivity pattern may give rise to spatially distinct receptive fields in a higher layer because the higher layer neurons in a given region may receive inputs that are tuned through training to the properties of a restricted portion of the total input to the network.

One example of a locally connected neural network is a convolutional neural network. FIG. 2C illustrates an example of a convolutional neural network 206. The convolutional neural network 206 may be configured such that the connection strengths associated with the inputs for each neuron in the second layer are shared (e.g., 208). Convolutional neural networks may be well suited to problems in which the spatial location of inputs is meaningful.

One type of convolutional neural network is a deep convolutional network (DCN). FIG. 2D illustrates a detailed example of a DCN 200 designed to recognize visual features from an image 226 input from an image capturing device 230, such as a car-mounted camera. The DCN 200 of the current example may be trained to identify traffic signs and a number provided on the traffic sign. Of course, the DCN 200 may be trained for other tasks, such as identifying lane markings or identifying traffic lights.

The DCN 200 may be trained with supervised learning. During training, the DCN 200 may be presented with an image, such as the image 226 of a speed limit sign, and a forward pass may then be computed to produce an output 222. The DCN 200 may include a feature extraction section and a classification section. Upon receiving the image 226, a convolutional layer 232 may apply convolutional kernels (not shown) to the image 226 to generate a first set of feature maps 218. As an example, the convolutional kernel for the convolutional layer 232 may be a 5×5 kernel that generates 28×28 feature maps. In the present example, because four different feature maps are generated in the first set of feature maps 218, four different convolutional kernels were applied to the image 226 at the convolutional layer 232. The convolutional kernels may also be referred to as filters or convolutional filters.

The first set of feature maps 218 may be subsampled by a max pooling layer (not shown) to generate a second set of feature maps 220. The max pooling layer reduces the size of the first set of feature maps 218. That is, a size of the second set of feature maps 220, such as 14×14, is less than the size of the first set of feature maps 218, such as 28×28. The reduced size provides similar information to a subsequent layer while reducing memory consumption. The second set of feature maps 220 may be further convolved via one or more subsequent convolutional layers (not shown) to generate one or more subsequent sets of feature maps (not shown).

In the example of FIG. 2D, the second set of feature maps 220 is convolved to generate a first feature vector 224. Furthermore, the first feature vector 224 is further convolved to generate a second feature vector 228. Each feature of the second feature vector 228 may include a number that corresponds to a possible feature of the image 226, such as “sign,” “60,” and “100.” A softmax function (not shown) may convert the numbers in the second feature vector 228 to a probability. As such, an output 222 of the DCN 200 may be a probability of the image 226 including one or more features.

In the present example, the probabilities in the output 222 for “sign” and “60” are higher than the probabilities of the others of the output 222, such as “30,” “40,” “50,” “70,” “80,” “90,” and “100”. Before training, the output 222 produced by the DCN 200 may likely be incorrect. Thus, an error may be calculated between the output 222 and a target output. The target output is the ground truth of the image 226 (e.g., “sign” and “60”). The weights of the DCN 200 may then be adjusted so the output 222 of the DCN 200 is more closely aligned with the target output.

To adjust the weights, a learning algorithm may compute a gradient vector for the weights. The gradient may indicate an amount that an error would increase or decrease if the weight were adjusted. At the top layer, the gradient may correspond directly to the value of a weight connecting an activated neuron in the penultimate layer and a neuron in the output layer. In lower layers, the gradient may depend on the value of the weights and on the computed error gradients of the higher layers. The weights may then be adjusted to reduce the error. This manner of adjusting the weights may be referred to as “back propagation” as it involves a “backward pass” through the neural network.

In practice, the error gradient of weights may be calculated over a small number of examples, so that the calculated gradient approximates the true error gradient. This approximation method may be referred to as stochastic gradient descent. Stochastic gradient descent may be repeated until the achievable error rate of the entire system has stopped decreasing or until the error rate has reached a target level. After learning, the DCN 200 may be presented with new images and a forward pass through the DCN 200 may yield an output 222 that may be considered an inference or a prediction of the DCN 200.

Deep belief networks (DBNs) are probabilistic models comprising multiple layers of hidden nodes. DBNs may be used to extract a hierarchical representation of training data sets. A DBN may be obtained by stacking up layers of Restricted Boltzmann Machines (RBMs). An RBM is a type of artificial neural network that can learn a probability distribution over a set of inputs. Because RBMs can learn a probability distribution in the absence of information about the class to which each input should be categorized, RBMs are often used in unsupervised learning. Using a hybrid unsupervised and supervised paradigm, the bottom RBMs of a DBN may be trained in an unsupervised manner and may serve as feature extractors, and the top RBM may be trained in a supervised manner (on a joint distribution of inputs from the previous layer and target classes) and may serve as a classifier.

Deep convolutional networks (DCNs) are networks of convolutional networks, configured with additional pooling and normalization layers. DCNs have achieved state-of-the-art performance on many tasks. DCNs can be trained using supervised learning in which both the input and output targets are known for many exemplars and are used to modify the weights of the network by use of gradient descent methods.

DCNs may be feed-forward networks. In addition, as described above, the connections from a neuron in a first layer of a DCN to a group of neurons in the next higher layer are shared across the neurons in the first layer. The feed-forward and shared connections of DCNs may be exploited for fast processing. The computational burden of a DCN may be much less, for example, than that of a similarly sized neural network that comprises recurrent or feedback connections.

The processing of each layer of a convolutional network may be considered a spatially invariant template or basis projection. If the input is first decomposed into multiple channels, such as the red, green, and blue channels of a color image, then the convolutional network trained on that input may be considered three-dimensional, with two spatial dimensions along the axes of the image and a third dimension capturing color information. The outputs of the convolutional connections may be considered to form a feature map in the subsequent layer, with each element of the feature map (e.g., 220) receiving input from a range of neurons in the previous layer (e.g., feature maps 218) and from each of the multiple channels. The values in the feature map may be further processed with a non-linearity, such as a rectification, max(0, x). Values from adjacent neurons may be further pooled, which corresponds to down sampling, and may provide additional local invariance and dimensionality reduction. Normalization, which corresponds to whitening, may also be applied through lateral inhibition between neurons in the feature map.

The performance of deep learning architectures may increase as more labeled data points become available or as computational power increases. Modern deep neural networks are routinely trained with computing resources that are thousands of times greater than what was available to a typical researcher just fifteen years ago. New architectures and training paradigms may further boost the performance of deep learning. Rectified linear units may reduce a training issue known as vanishing gradients. New training techniques may reduce over-fitting and thus enable larger models to achieve better generalization. Encapsulation techniques may abstract data in a given receptive field and further boost overall performance.

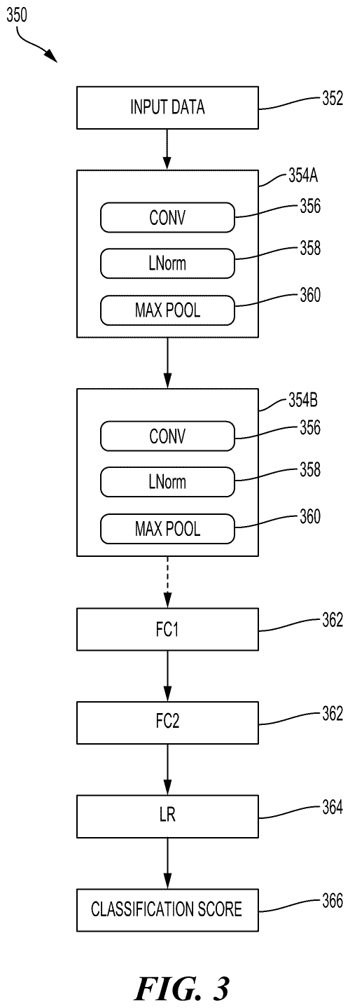

FIG. 3 is a block diagram illustrating a deep convolutional network (DCN) 350. The DCN 350 may include multiple different types of layers based on connectivity and weight sharing. As shown in FIG. 3, the DCN 350 includes the convolution blocks 354A, 354B. Each of the convolution blocks 354A, 354B may be configured with a convolution layer (CONV) 356, a normalization layer (LNorm) 358, and a max pooling layer (MAX POOL) 360. Although only two of the convolution blocks 354A, 354B are shown, the present disclosure is not so limiting, and instead, any number of the convolution blocks 354A, 354B may be included in the DCN 350 according to design preference.

The convolution layers 356 may include one or more convolutional filters, which may be applied to the input data to generate a feature map. The normalization layer 358 may normalize the output of the convolution filters. For example, the normalization layer 358 may provide whitening or lateral inhibition. The max pooling layer 360 may provide down sampling aggregation over space for local invariance and dimensionality reduction.

The parallel filter banks, for example, of a deep convolutional network may be loaded on a CPU 102 or GPU 104 of an SOC 100 (e.g., FIG. 1) to achieve high performance and low power consumption. In alternative embodiments, the parallel filter banks may be loaded on the DSP 106 or an ISP 116 of an SOC 100. In addition, the DCN 350 may access other processing blocks that may be present on the SOC 100, such as sensor processor 114 and navigation module 120, dedicated, respectively, to sensors and navigation.

The DCN 350 may also include one or more fully connected layers 362 (FC1 and FC2). The DCN 350 may further include a logistic regression (LR) layer 364. Between each layer 356, 358, 360, 362, 364 of the DCN 350 are weights (not shown) that are to be updated. The output of each of the layers (e.g., 356, 358, 360, 362, 364) may serve as an input of a succeeding one of the layers (e.g., 356, 358, 360, 362, 364) in the DCN 350 to learn hierarchical feature representations from input data 352 (e.g., images, audio, video, sensor data and/or other input data) supplied at the first of the convolution blocks 354A. The output of the DCN 350 is a classification score 366 for the input data 352. The classification score 366 may be a set of probabilities, where each probability is the probability of the input data including a feature from a set of features.

Despite recent advances in computer vision and deep learning, optical flow estimation is still a challenging problem. Most conventional optical flow estimation systems aim to improve accuracy by designing complex neural network architectures, adjusting model training, or implementing low-level changes to training images (e.g., data augmentation). These low-level changes may include, but are not limited to, altering colors, hiding parts of the image, and/or flipping the training images. In most cases, such changes focus on simple, visual features of the image and do not capture complex, real-world variations. Various aspects of the present disclosure are directed to adding real-world complexity to the training images, in contrast to making small visual changes.

Additionally, or alternatively, some conventional optical flow estimation systems use semi-supervised learning methods to try to use unlabeled data during training. In most cases, these conventional optical flow estimation systems use complicated techniques involving two different networks to make use of the unlabeled data. In contrast, aspects of the present disclosure use uncertainty-aware pseudo-labeling. Therefore, rather than using two different networks, various aspects of the present disclosure use two different sets of images. In some examples, the optical flow estimation model is trained on the most reliable parts of these images, thereby improving the accuracy of the model. The most reliable parts of these images may be identified based on a confidence map.

Various aspects of the present disclosure are directed to improving the accuracy of the optical flow estimation. In some examples, a novel data augmentation technique may be specified to improve optical flow estimation by incorporating realistic, high-level distractions generated from one or more images. This approach provides a more nuanced and semantically meaningful augmentation compared to conventional optical flow estimation systems that mainly focus on low-level visual adjustments. Additionally, in some examples, a semi-supervised learning technique is specified to use distracted pairs of frames to leverage unlabeled data. The semi-supervised learning technique may incorporate a confidence map to create uncertainty-aware pseudo-labels. The improved training procedure may be agnostic, such that the training procedure is not limited to a specific type of optical flow estimation model.

As discussed, some aspects are directed to improving the training procedure of the optical flow estimation model. In such aspects, training data may be augmented with noise. In some examples, the noise may be another image. For example, one or more frames from a first set of training frames may be augmented with one or more frames from a second set of training frames. Specifically, a frame from the second set of frames may be superimposed onto a frame from the first set of training frames.

As an example, a pair of video frames (Iₜ, Iₜ₊₁) may be used during training. The distracted version of the pair of video frames may be denoted as (Iₜ, D_{λ}(Iₜ₊₁, Ĩ_{d}), where D_{λ}(Iₜ₊₁, Ĩ_{d}) is a perturbed second frame obtained by combing a frame I at time t+1 with another image Ĩ_{d} based on a mixing ratio of λ∈(0,1). In some implementations, the perturbed second frame D_{λ}(Iₜ₊₁, Ĩ_{d}) may be calculated as λ. Iₜ₊₁+(1−λ)·Ĩ_{d}. The mixing ratio λ may be sampled from a Beta(α, α) distribution, such that the mixing ratio λ is randomly selected based on the parameter α.

In some examples, the perturbed second frame D_{λ}(Iₜ₊₁, Ĩ_{d}) may be generated by overlaying actual objects and/or real scenes from one image onto a second image, simulating various challenging real-world conditions. These conditions may include (but are not limited to) emerging foreground or background objects, motion blur, out-of-focus elements, reflections on shiny surfaces, and/or partial blockages of the view. Additionally, because the distracting elements are sourced from the same dataset, the distracting elements maintain a visual context that is consistent with the original pair of images. For example, both the original and distracting images may feature similar elements, such as roads, cars, and buildings. The layout of these elements within the frame—such as roads typically appearing at the bottom and the sky at the top—also remains consistent.

In some examples, to provide supervision on the distracted pair of frames, a ground-truth flow of the original pair may be used to calculate the loss of a distracted pair [symbol] _{dist}, which is computed as follows:

[symbol]

_{dist}=∥V_{(I}_{ₜ}_{, I}_{ₜ₊₁}₎^{f}−f(Iₜ, D_{λ}(Iₜ₊₁, Ĩ_{d}))∥₁. (1)

In Equation 1, V_{(I}_{ₜ}_{, I}_{ₜ₊₁}₎^{f} represents the ground-truth forward flow for the original pair (Iₜ, Iₜ₊₁) and f(⋅,⋅) denotes the predicted flow based on an optical flow estimation model f. In a supervised learning setting, where all training samples are labeled, the total training loss [symbol] ₛᵤₚ may be calculated as:

[symbol]

ₛᵤₚ= [symbol] _{base}+w_{dist} [symbol] _{dist}, (2)

where L_{base} represents the conventional supervised loss and w_{dist}>0 is a weighing factor for the distracted pair loss [symbol] _{dist}. For iterative models, this loss [symbol] ₛᵤₚ may be applied at each recurrent iteration.

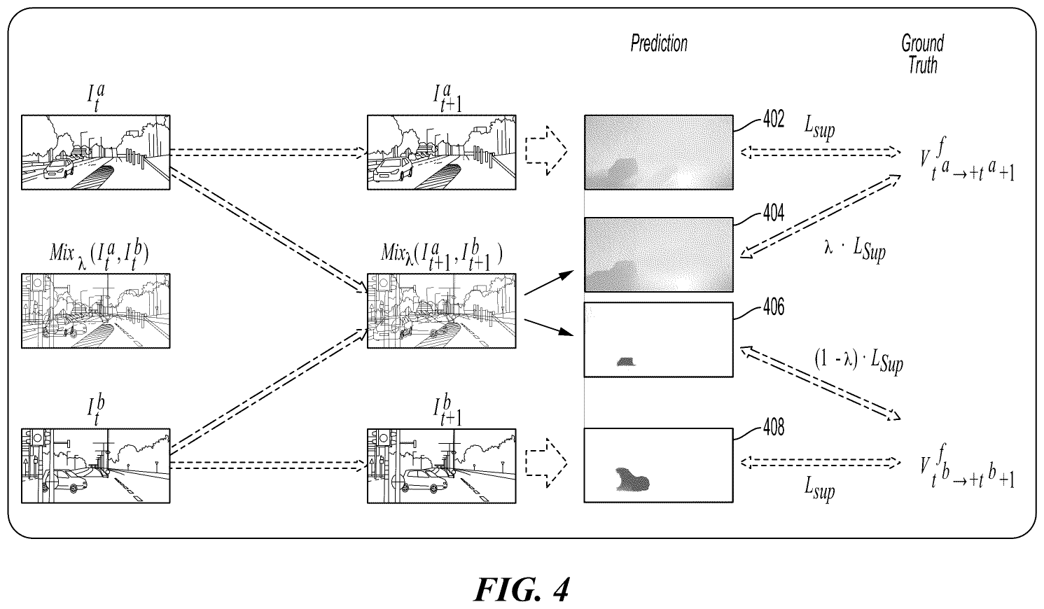

FIG. 4 is a block diagram illustrating an example of a supervised training procedure for optical flow estimation, in accordance with various aspects of the present disclosure. In the example of FIG. 4, the optical flow estimation model may be trained on two sets of frames, each set includes a pair of frames. For example, a first pair a includes a first frame Iₜ^{a} and a second frame Iₜ₊₁^{a}, and a second pair b includes a first frame Iₜ^{b} and a second frame Iₜ₊₁^{b}. Each pair of frames may be from a respective sequence of frames. The optical flow estimation model may be trained on multiple pairs of frames from the sequence of frames. Additionally, as shown in FIG. 4, an augmented pair of frames may be generated by interpolating (e.g., mixing) the first frames Iₜ^{a}, Iₜ^{b} of the first and second pairs a, b, and also interpolating the second frames Iₜ₊₁^{a}, Iₜ₊₁^{b} of the first and second pairs a, b. Specifically, as shown in FIG. 4, the augmented pair of frames includes a first frame Mix_{λ}(Iₜ^{a}, Iₜ^{b}) and a second frame Mix_{λ}(Iₜ₊₁^{a}, Iₜ₊₁^{b}).

After generating the augmented pair of frames, the optical flow estimation model may estimate a flow between the first frame and second frame of each pair a, b, and also the first frame Iₜ^{a}, Iₜ^{b} of each pair a, b and a second frame Mix₈₀ (Iₜ₊₁^{a}, Iₜ₊₁^{b}) of the augmented pair. For example, as shown in FIG. 4, the optical flow estimation model generates a first flow estimation 402 based on the first frame Iₜ^{a} and the second frame iₜ₊₁^{a} of the first pair a. Additionally, the optical flow estimation model generates a second flow estimation 404 based on the first frame Iₜ^{a} of the first pair a and the second frame Mix_{λ}(Iₜ₊₁^{a}, Iₜ₊₁^{b}) of the augmented pair. The first frame Iₜ^{a} of the first pair a and the second frame Mix_{λ}(Iₜ₊₁^{a}, Iₜ₊₁^{b}) of the augmented pair may be referred to as a first augmented pair (Iₜ^{a}, Mix_{λ}(Iₜ₊₁^{a}, Iₜ₊₁^{b})). A third flow estimation 406 is based on the first frame Iₜ^{b} of the second pair b and the second frame Mix_{λ}(Iₜ₊₁^{a}, Iₜ₊₁^{b}) of the augmented pair. The first frame Iₜ^{b} of the second pair b and the second frame Mix_{λ}(Iₜ₊₁^{a}, Iₜ₊₁^{b}) of the augmented pair may be referred to as a second augmented pair (Iₜ^{b}, Mix_{λ}(Iₜ₊₁^{a}, Iₜ₊₁^{b})). A fourth flow estimation 408 is based on the first frame Iₜ^{b} and second frame Iₜ₊₁^{b} of the second pair b.

The estimations 402, 404, 406, 408 (e.g., predictions) of the optical flow estimation model may be supervised based on a ground truth associated with a corresponding original pair a, b. For example, parameters of the optical flow estimation model may be updated to minimize a loss [symbol] ₛᵤₚ between the first flow estimation 402 and a ground truth of the first pair Vₜ_{^{a}}_{→+t}_{^{a}}₊₁^{f}, where the ground truth represents the visual flow between the first frame Iₜ^{a} and the second frame Iₜ₊₁^{a}. The ground truth of the first pair Vₜ_{^{a}}_{→+t}_{^{a}}₊₁^{f} may be an example of a training target. Additionally, parameters of the optical flow estimation model may be updated to minimize a loss λ [symbol] ₛᵤₚ between the second flow estimation 404 and the ground truth of the first pair Vₜ_{^{a}}_{→+t}_{^{a}}₊₁^{f}, where the parameter λ represents a percentage of the second frame Iₜ₊₁^{a} of the first pair a that is mixed with the second frame Iₜ₊₁^{b} of the second pair b. Furthermore, parameters and/or weights of the optical flow estimation model may be updated to minimize a loss (1−λ) [symbol] ₛᵤₚ between the third flow estimation 406 and a ground truth of a second pair Vₜ_{^{b}}_{→+t}_{^{b}}₊₁^{f}. Finally, parameters and/or weights of the optical flow estimation model may be updated to minimize the loss [symbol] ₛᵤₚ between the fourth flow estimation 408 and the ground truth of the second pair Vₜ_{^{b}}_{→+t}_{^{b}}₊₁^{f}. The ground truth of the second pair Vₜ_{^{b}}_{→t}_{^{b}}₊₁^{f} may be an example of a training target.

In some examples, a prediction (e.g., estimated optical flow) from an original pair of frames, such as the first frame Iₜ^{a} and the second frame Iₜ₊₁^{a} from the first pair a as described with reference to FIG. 4, may be used as a pseudo-label or a training target when unlabeled data is available during training. In such examples, an augmented frame or a pair of augmented frames may be used to derive a self-supervised loss. That is, during training, when unlabeled frame pairs are available, a distracted pair of frames may be used to derive additional self-supervised regularization. In some examples, given a distracted pair of frames (Iₜ, D_{λ}(Iₜ₊₁, Ĩ_{d})), and the original pair of frames (Iₜ, Iₜ₊₁), the optical flow estimation model's prediction may be enforced on the distracted pair to match the prediction on the original pair. In such examples, the prediction on the original pair, f(Iₜ, Iₜ₊₁) may be used as a pseudo-label. By using the predication on the original pair, f(Iₜ, Iₜ₊₁) as a pseudo-label, the model learns to produce an optical flow estimation from the distracted pair that may be similar to or consistent with an optical flow estimation of the original pair, despite the distractions. This form of self-supervised regularization improves the optical flow estimation model's ability to handle real-world data robustly.

In some cases, using the entire prediction f(Iₜ, iₜ₊₁) as the training target for the distracted pair poses a challenge. The model's predictions on the original frame pairs can be noisy or incorrect during the training process. Relying on these low-quality pseudo-labels could negatively impact the training and even lead to unstable learning. To mitigate this problem, uncertainty-aware pseudo-labels may be introduced by calculating a confidence map. This confidence map may be based on forward-backward consistency, and predictions with pixel predictions associated with a confidence greater than a threshold may be used as a pseudo-ground truth. As an example, for a frame pair (Iₜ, Iₜ₊₁), \hat{V}^{f}(x) and \hat{V}^{b}(x) represent the predicted forward and backward flows at the pixel location x. If these predicted flows \hat{V}^{f}(x) and \hat{V}^{b}(x) satisfy a specific constraint, the predicted flows \hat{V}^{f}(x) and \hat{V}^{b}(x) may be considered accurate. The constraint may be defined as follows:

|\hat{V}^{f}(x)+\hat{V}^{b}(x+\hat{V}^{f}(x))|²<γ₁(|\hat{V}^{f}|²+|\hat{V}^{b}(x+\hat{V}^{f}(x))|²)+γ₂. (3)

In Equation 3, parameters γ₁ and γ₂ represent constants to set the threshold for deciding whether a predicted optical flow is accurate or not. In some examples, γ₁=0.01 and γ₂=0.5. In some implementations, a confidence map M_{conf} may be derived as follows:

$${M}_{conf} = exp ( - \frac{{\vert {\hat{V}}^{f} ( x ) + {\hat{V}}^{b} ( x + {\hat{V}}^{f} ( x ) ) \vert}^{2}}{{γ}_{1} ( {\vert {\hat{V}}^{f} \vert}^{2} + {\vert {\hat{V}}^{b} ( x + {\hat{V}}^{f} ( x ) ) \vert}^{2} ) + {γ}_{2}} ) . \qquad ( 4 )$$

The confidence map M_{conf} provides a measure of reliability of the predicted optical flow. In some examples, the confidence map M_{conf} provides a measure of a confidence in the model's flow predictions at each pixel location. The confidence map M_{conf} uses both forward and backward flow predictions to assess the accuracy and reliability of the estimated flow at a given pixel. The confidence map M_{conf} guides the training process by focusing on those regions where the model's predictions are more reliable. In some examples, the confidence map M_{conf} may be used to modify a self-supervised regularization loss [symbol] _{self}. This loss [symbol] _{self} may be defined as a difference between predicted flows of the original pair f(Iₜ, Iₜ₊₁) and the distracted pair f(Iₜ, D_{λ}(Iₜ₊₁, Ĩ_{d})), but only for pixels where the confidence, based on the confidence map M_{conf}, exceeds a certain threshold τ (M_{conf}≥τ):

[symbol]

_{self}=∥[M_{conf}≥τ](f(Iₜ, Iₜ₊₁)−f(Iₜ, D_{λ}(Iₜ₊₁, Ĩ_{d})))∥₁,

where [⋅] represents an Iverson bracket. The Iverson bracket may return a value of one if a condition within the bracket is true and a value of zero otherwise.

In the context of semi-supervised learning, where both labeled and unlabeled data are used, the total loss [symbol] ₜₒₜₐₗ is calculated as the sum of the supervised loss [symbol] ₛᵤₚ and the weighted self-supervised loss w_{self} [symbol] _{self}(e.g., [symbol] ₜₒₜₐₗ= [symbol] ₛᵤₚ+w_{self} [symbol] _{self}), where w_{self}>0. The parameter w_{self} represents a weight applied to the self-supervised loss, allowing for a balanced combination of supervised and self-supervised losses during training.

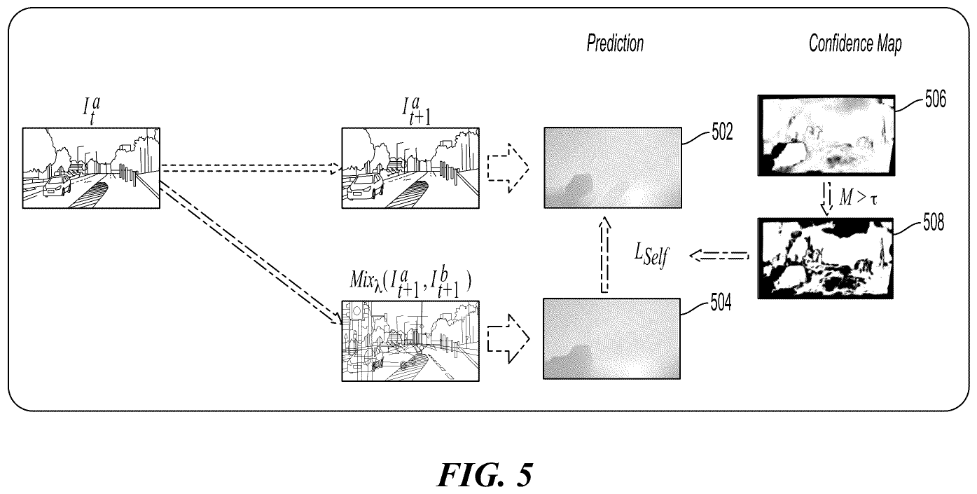

FIG. 5 is a block diagram illustrating an example of a self-supervised training procedure for optical flow estimation, in accordance with various aspects of the present disclosure. In the example of FIG. 5, an optical flow estimation model may be trained on a pair of frames (Iₜ, Iₜ₊₁). The pair of frames may be from a sequence of frames. The optical flow estimation model may be trained on multiple pairs of frames from the sequence of frames. For example, a pair of frames a includes a first frame It and a second frame Iₜ₊₁^{a}. Additionally, an augmented pair of frames may be generated by interpolating (e.g., mixing) the first frame Iₜ^{a} and also interpolating the second frame Iₜ₊₁^{a}. The augmented pair of frames includes a first frame Mix_{λ}(Iₜ^{a}, Iₜ^{b}) and a second frame Mix_{λ}(Iₜ₊₁^{a}, Iₜ₊₁^{b}). For brevity, FIG. 5 only shows the second frame Mix_{λ}(Iₜ₊₁^{a}, Iₜ₊₁^{b}). Each frame Iₜ^{a} and Iₜ₊₁^{a} may be augmented with another image, noise, or distortion of the current frame, or another frame in the sequence of frames.

After generating the augmented pair of frames, the optical flow estimation model may estimate a flow between the first frame and second frame of the pair a, and also the first frame it of the pair a and the second frame Mix_{λ}(Iₜ₊₁^{a}, Iₜ₊₁^{b}) of the augmented pair. For example, as shown in FIG. 5, the optical flow estimation model generates a first flow estimation 502 based on the first frame it and the second frame Iₜ₊₁^{a} of the pair a. Additionally, the optical flow estimation model generates a second flow estimation 504 based on the first frame Iₜ^{a} of the pair a and the second frame Mix_{λ}(Iₜ₊₁^{a}, Iₜ₊₁^{b}) of the augmented pair. The first frame Iₜ^{a} of the pair a and the second frame Mix_{λ}(Iₜ₊₁^{a}, Iₜ₊₁^{b}) of the augmented pair may be referred to as a first augmented pair (Iₜ^{a}, Mix_{λ}(Iₜ₊₁^{a}, Iₜ₊₁^{b})).

In some examples, the first flow estimation 502 may be used as a pseudo-label or a training target. Parameters and/or weights of the optical flow estimation model may be updated to minimize a loss [symbol] _{self} between the first flow estimation 502 and the second flow estimation 504. That is, the parameters and/or weights should be updated such that the second flow estimation 504 matches the first flow estimation 502. In some examples, the first flow estimation 502 may be erroneous or noisy. Therefore, a first confidence map 506 based on the first flow estimation 502 (e.g., pseudo-label) may be used as the training target or pseudo-label instead of the first flow estimation 502 when determining the loss [symbol] _{self}. The first confidence map 506 may be filtered to keep pixel-wise predictions with a confidence M that is greater than a confidence threshold τ. Thus, a second confidence map 508, where M>τ, may be used to determine the loss [symbol] _{self}.

FIG. 6 illustrates a process 600 for training an optical flow estimation model, in accordance with various aspects of the present disclosure. The process may be implemented by a neural network device, such as the SOC 100 described with reference to FIG. 1. As shown in FIG. 6, the process 600 may begin at block 602, by generating a first augmented frame by combining a first image and a first frame of a first frame pair. At block 604, the process 600 generates, via an optical flow estimation model, a first flow estimation based on a second frame of the first frame pair and the first augmented frame. At block 606, the process 600 updates one or both of parameters or weights of the optical flow estimation model based on a first loss between the first flow estimation and a training target.

Implementation examples are described in the following numbered clauses:
Clause 1. A computer-implemented method, comprising: generating a first augmented frame by combining a first image and a first frame of a first frame pair; generating, via an optical flow estimation model, a first flow estimation based on a second frame of the first frame pair and the first augmented frame; and updating one or both of parameters or weights of the optical flow estimation model based on a first loss between the first flow estimation and a training target.
Clause 2. The computer-implemented method of Clause 1, further comprising generating a second augmented frame by combining a second image and the second frame, wherein: the first image and the second image correspond to different frames of a second frame pair; and the second frame pair is different than the first frame pair.
Clause 3. The computer-implemented method of any one of Clause 2, further comprising generating, via the optical flow estimation model, a second flow estimation based on the first frame and the second frame.
Clause 4. The computer-implemented method of Clause 3, further comprising updating one or both of the parameters or the weights of the optical flow estimation model to minimize a second loss between the second flow estimation and the training target.
Clause 5. The computer-implemented method of Clause 4, wherein the training target is a ground truth visual flow between the first frame and the second frame.
Clause 6. The computer-implemented method of Clause 4, wherein the first loss is based, at least in part, on a mixing ratio indicating a ratio of the second image combined with the second frame.
Clause 7. The computer-implemented method of Clause 3, wherein the training target is the second flow estimation.
Clause 8. The computer-implemented method of Clause 3, further comprising generating a confidence map based on the second flow estimation, wherein the training target is the confidence map.
Clause 9. The computer-implemented method of Clause 8, wherein the confidence map excludes each pixel associated with a confidence that is less than a confidence threshold.
Clause 10. The computer-implemented method of any one of Clauses 1-9, wherein combining the first image and the first frame comprises superimposing the first image onto the first frame.
Clause 11. The computer-implemented method of any one of Clauses 1-10, wherein the first frame pair is a pair of frames from a sequence of frames.
Clause 12. An apparatus comprising a processor, memory coupled with the processor, and instructions stored in the memory and operable, when executed by the processor to cause the apparatus to perform any one of Clauses 1 through 11,
Clause 13. An apparatus comprising at least one means for performing any one of Clauses 1 through 11.
Clause 14. A computer program comprising code for causing an apparatus to perform any one of Clauses 1 through 11.
Clause 15. A computer-implemented method, comprising receiving a first frame and a second frame; and estimating via an optical flow estimation model, an optical flow between the first frame and the second frame, the optical flow estimation model being trained by: generating a first augmented frame by combining a first image and a first training frame of a training frame pair; generating a first flow estimation based on a second training frame of the training frame pair and the first augmented frame; and updating one or both of parameters or weights of the optical flow estimation model based on a first loss between the first flow estimation and a training target
Clause 16. The computer-implemented method of Clause 15, wherein the optical flow estimation model is further trained in accordance with any one of Clauses 1-11.
Clause 17. An apparatus, comprising: one or more processors; and one or more memories coupled with the one or more processors and storing instructions operable, when executed by the one or more processors, to cause the apparatus to: receive a first frame and a second frame; and estimate, via an optical flow estimation model, an optical flow between the first frame and the second frame, the optical flow estimation model being trained by: generating a first augmented frame by combining a first image and a first training frame of a training frame pair; generating a first flow estimation based on a second training frame of the training frame pair and the first augmented frame; and updating one or both of parameters or weights of the optical flow estimation model based on a first loss between the first flow estimation and a training target.
Clause 18. The apparatus of Clause 17, wherein the optical flow estimation model is further trained in accordance with any one of Clauses 1-11.

The various operations of methods described above may be performed by any suitable means capable of performing the corresponding functions. The means may include various hardware and/or software component(s) and/or module(s), including, but not limited to, a circuit, an application specific integrated circuit (ASIC), or processor. Generally, where there are operations illustrated in the figures, those operations may have corresponding counterpart means-plus-function components with similar numbering.

As used, the term “determining” encompasses a wide variety of actions. For example, “determining” may include calculating, computing, processing, deriving, investigating, looking up (e.g., looking up in a table, a database, or another data structure), ascertaining and the like. Additionally, “determining” may include receiving (e.g., receiving information), accessing (e.g., accessing data in a memory) and the like. Furthermore, “determining” may include resolving, selecting, choosing, establishing, and the like.

As used, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules and circuits described in connection with the present disclosure may be implemented or performed with a general-purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, erasable programmable read-only memory (EPROM), electrically erasable programmable read-only memory (EEPROM), registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, random access memory (RAM), flash memory, read only memory (ROM), programmable read-only memory (PROM), erasable programmable read-only memory (EPROM), electrically erasable programmable Read-only memory (EEPROM), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or general register files. Although the various components discussed may be described as having a specific location, such as a local component, they may also be configured in various ways, such as certain components being configured as part of a distributed computing system.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may comprise one or more neuromorphic processors for implementing the neuron models and models of neural systems described. As another alternative, the processing system may be implemented with an application specific integrated circuit (ASIC) with the processor, the bus interface, the user interface, supporting circuitry, and at least a portion of the machine-readable media integrated into a single chip, or with one or more field programmable gate arrays (FPGAs), programmable logic devices (PLDs), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module. Furthermore, it should be appreciated that aspects of the present disclosure result in improvements to the functioning of the processor, computer, machine, or other system implementing such aspects.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Additionally, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used, include compact disc (CD), laser disc, optical disc, digital versatile disc (DVD), floppy disk, and Blu-ray® disc where disks usually reproduce data magnetically, while discs reproduce data optically with lasers. Thus, in some aspects, computer-readable media may comprise non-transitory computer-readable media (e.g., tangible media). In addition, for other aspects computer-readable media may comprise transitory computer- readable media (e.g., a signal). Combinations of the above should also be included within the scope of computer-readable media.

Thus, certain aspects may comprise a computer program product for performing the operations presented. For example, such a computer program product may comprise a computer-readable medium having instructions stored (and/or encoded) thereon, the instructions being executable by one or more processors to perform the operations described. For certain aspects, the computer program product may include packaging material.

Further, it should be appreciated that modules and/or other appropriate means for performing the methods and techniques described can be downloaded and/or otherwise obtained by a user terminal and/or base station as applicable. For example, such a device can be coupled to a server to facilitate the transfer of means for performing the methods described. Alternatively, various methods described can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described to a device can be utilized.

It is to be understood that the claims are not limited to the precise configuration and components illustrated above. Various modifications, changes, and variations may be made in the arrangement, operation, and details of the methods and apparatus described above without departing from the scope of the claims.

What is claimed is:

1. A computer-implemented method, comprising:
generating a first augmented frame by combining a first image and a first frame of a first frame pair;
generating, via an optical flow estimation model, a first flow estimation based on a second frame of the first frame pair and the first augmented frame; and
updating one or both of parameters or weights of the optical flow estimation model based on a first loss between the first flow estimation and a training target.

2. The computer-implemented method of claim 1, further comprising generating a second augmented frame by combining a second image and the second frame, wherein:
the first image and the second image correspond to different frames of a second frame pair; and
the second frame pair is different than the first frame pair.

3. The computer-implemented method of claim 2, further comprising generating, via the optical flow estimation model, a second flow estimation based on the first frame and the second frame.

4. The computer-implemented method of claim 3, further comprising updating one or both of the parameters or the weights of the optical flow estimation model to minimize a second loss between the second flow estimation and the training target.

5. The computer-implemented method of claim 4, wherein the training target is a ground truth visual flow between the first frame and the second frame.

6. The computer-implemented method of claim 4, wherein the first loss is based, at least in part, on a mixing ratio indicating a ratio of the first image combined with the first frame.

7. The computer-implemented method of claim 3, wherein the training target is the second flow estimation.

8. The computer-implemented method of claim 3, further comprising generating a confidence map based on the second flow estimation, wherein the training target is the confidence map.

9. The computer-implemented method of claim 8, wherein the confidence map excludes each pixel associated with a confidence that is less than a confidence threshold.

10. The computer-implemented method of claim 1, wherein the first image and the first frame are combined by superimposing the first image onto the first frame.

11. The computer-implemented method of claim 1, wherein the first frame pair is a pair of frames from a sequence of frames.

12. An apparatus, comprising:
one or more processors; and
one or more memories coupled with the one or more processors and storing instructions operable, when executed by the one or more processors, to cause the apparatus to:
generate a first augmented frame by combining a first image and a first frame of a first frame pair;
generate, via an optical flow estimation model, a first flow estimation based on a second frame of the first frame pair and the first augmented frame; and
update one or both of parameters or weights of the optical flow estimation model based on a first loss between the first flow estimation and a training target.

13. The apparatus of claim 12, wherein:
execution of the instructions further cause the apparatus to generate a second augmented frame by combining a second image and the second frame;
the first image and the second image correspond to different frames of a second frame pair;
the second frame pair is different than the first frame pair; and
each of the first frame pair and the second frame pair is a pair of frames from a sequence of frames.

14. The apparatus of claim 13, wherein execution of the instructions further cause the apparatus to generate, via the optical flow estimation model, a second flow estimation based on the first frame and the second frame.

15. The apparatus of claim 14, wherein execution of the instructions further cause the apparatus to update one or both of the parameters or the weights of the optical flow estimation model to minimize a second loss between the second flow estimation and the training target.

16. The apparatus of claim 15, wherein the training target is a ground truth visual flow between the first frame and the second frame.

17. The apparatus of claim 15, wherein the first loss is based, at least in part, on a mixing ratio indicating a ratio of the second image combined with the second frame.

18. The apparatus of claim 14, wherein the training target is the second flow estimation.

19. The apparatus of claim 14, wherein execution of the instructions further cause the apparatus to:
generate a confidence map based on the second flow estimation, wherein the training target is the confidence map; and
exclude each pixel associated with a confidence that is less than a confidence threshold.

20. The apparatus of claim 12, wherein the first image and the first frame are combined by superimposing the first image onto the first frame.

21. A non-transitory computer-readable medium having program code recorded thereon, the program code executed by a processor and comprising:
program code to generate a first augmented frame by combining a first image and a first frame of a first frame pair;
program code to generate, via an optical flow estimation model, a first flow estimation based on a second frame of the first frame pair and the first augmented frame; and
program code to update one or both of parameters or weights of the optical flow estimation model based on a first loss between the first flow estimation and a training target.

22. The non-transitory computer-readable medium of claim 21, wherein:
the program code further includes program code to generate a second augmented frame by combining a second image and the second frame;
the first image and the second image correspond to different frames of a second frame pair;
the second frame pair is different than the first frame pair; and
each of the first frame pair and the second frame pair is a pair of frames from a sequence of frames.

23. The non-transitory computer-readable medium of claim 22, wherein the program code further comprises program code to generate, via the optical flow estimation model, a second flow estimation based on the first frame and the second frame.

24. The non-transitory computer-readable medium of claim 23, wherein the program code further comprises program code to update one or both of the parameters or the weights of the optical flow estimation model to minimize a second loss between the second flow estimation and the training target.

25. The non-transitory computer-readable medium of claim 24, wherein the training target is a ground truth visual flow between the first frame and the second frame.

26. The non-transitory computer-readable medium of claim 24, wherein the first loss is based, at least in part, on a mixing ratio indicating a ratio of the second image combined with the second frame.

27. The non-transitory computer-readable medium of claim 23, wherein the training target is the second flow estimation.

28. The non-transitory computer-readable medium of claim 23, wherein:
the program code further comprises:
program code to generate a confidence map based on the second flow estimation; and
program code to exclude each pixel associated with a confidence that is less than a confidence threshold; and
the training target is the confidence map.

29. The non-transitory computer-readable medium of claim 21, wherein the first image and the first frame are combined by superimposing the first image onto the first frame.

30. An apparatus, comprising:
one or more processors; and
one or more memories coupled with the one or more processors and storing instructions operable, when executed by the one or more processors, to cause the apparatus to:
receive a first frame and a second frame; and
estimate, via an optical flow estimation model, an optical flow between the first frame and the second frame, the optical flow estimation model being trained by:
generating a first augmented frame by combining a first image and a first training frame of a training frame pair;
generating a first flow estimation based on a second training frame of the training frame pair and the first augmented frame; and
updating one or both of parameters or weights of the optical flow estimation model based on a first loss between the first flow estimation and a training target.
